(19) United States
(12) Patent Application Publication
(10) Pub. No.: US 2024/0318683 A1
(43) Pub. Date: Sep. 26, 2024

(54) HOLD-TOGETHER ASSEMBLY AND METHOD

(71) Applicant: Honda Motor Co., Ltd., Tokyo (JP)

(72) Inventor: Travis M. REEL, Ostrander, OH (US)

(21) Appl. No.: 18/187,498

(22) Filed: Mar. 21, 2023

(51) Int. Cl. F16B 39/24; B60R 22/18; F16B 43/00

(52) U.S. Cl. CPC F16B 39/24; B60R 22/18; F16B 43/00; B60R 2022/1806

(57) ABSTRACT

A hold-together assembly and method includes a working part adapted to be secured to an associated mounting part, a threaded member having a shaft portion received through an aperture in the working part, an optional washer annularly received on the shaft portion of the threaded member for holding the threaded member relative to the working part and at least one deformation formed in the optional washer or the working part to axially secure the working part to the shaft portion of the threaded member for inhibiting axial movement between the working part and the threaded member while allowing relative rotation between the shaft portion of the threaded member and the working part.

### BACKGROUND

Mounting and hold-together assemblies are often provided for transportation and/or handling of a vehicle part. For example, for a vehicle seat, the mounting assemblies can be connected to a seat belt webbing and/or a seat belt harness and arranged to maintain positioning relative to the vehicle seat for later installation. If the arrangement of the mounting assembly is not proper, components of the mounting assembly can become misaligned making the later installation of the vehicle seat cumbersome and time-consuming. There are continuous downward cost pressures on vehicle manufacturing and parts thereof. Accordingly, elimination of parts in various subassemblies without corresponding loss of function related to the eliminated part can yield a cost advantage.

### BRIEF DESCRIPTION

According to one aspect, a hold-together assembly includes a working part adapted to be secured to an associated mounting part, a threaded member having a shaft portion received through an aperture in the working part, an optional washer annularly received on the shaft portion of the threaded member for holding the threaded member relative to the working part and at least one deformation formed in the optional washer or the working part to axially secure the working part to the shaft portion of the threaded member for inhibiting axial movement between the working part and the threaded member while allowing relative rotation between the shaft portion of the threaded member and the working part.

According to another aspect, a hold-together assembly for a vehicle sub-assembly includes a working part adapted to be secured to an associated vehicle mounting part, a bolt received through a bolt aperture defined in the working part and at least one deformation extending axially into or toward the bolt to axially inhibit movement between the bolt and the working part while allowing relative rotation between the bolt and the working part.

According to a further aspect, a hold-together assembly method includes providing a working part adapted to be secured to an associated mounting part and a threaded member having a shaft portion received through an aperture in the working part. The method further includes optionally providing a washer annularly received on the shaft portion of the threaded member and deforming at least one of the optional washer or the working part to axially secure the working part to the shaft portion of the threaded member for inhibiting axial movement between the working part and the threaded member while allowing relative rotation between the shaft portion of the threaded member and the working part.

### BRIEF DESCRIPTION OF THE DRAWINGS

FIG. 1 is a schematic view of a known hold-together assembly having a toothed washer for transportation and/or handling of a working part (e.g., a seatbelt anchor plate or bracket) adapted to be secured to an associated mounting part (e.g., a seat frame).

FIG. 2 is a partial perspective cross-section view of the hold-together assembly of claim 1.

FIG. 3 is a partial cross-section view of a hold-together assembly according to one aspect of the present disclosure.

FIG. 4 is a partial cross-section view of the hold-together assembly of FIG. 4 showing a washer of the hold-together assembly being radially deformed into a threaded member of the hold-together assembly.

FIGS. 5A, 5B and 5C are schematic views of the washer and the threaded member of FIGS. 3 and 4 showing, respectively, an initial stage, a radial deformation stage and a post radial deformation stage.

FIGS. 6A, 6B and 6C are schematic views of an alternate embodiment wherein a combined axial and radial deformation force is applied to an axial surface of the washer.

FIGS. 7 and 8 are schematic cross section views of a further alternate embodiment similar to the embodiment of FIGS. 6A-6C but with an alternate washer having an axial groove adapted to matingly receive tool dies for receipt of a combined axial and radial deformation force.

FIG. 9 is a partial cross-section view of a hold-together assembly according to a further aspect of the present disclosure showing a washer of the hold-together assembly receiving an axial deformation force being applied to axial surface of the washer.

FIGS. 10A, 10B and 10C are schematic views of the washer and the threaded member of FIG. 9 showing, respectively, an initial stage, an axial deformation stage and a post axial deformation stage.

FIG. 11 is a partial cross-section view of a hold-together assembly according to still another aspect of the present disclosure showing a threaded member of the hold-together assembly having a radial recess for receipt of a deformed working part of the hold-together assembly.

FIG. 12 is a partial cross-section view similar to FIG. 11 but showing the working part deformed into the radial recess.

FIG. 13 is an exemplary process flow diagram of a hold-together assembly method in accord with a further aspect of the present disclosure.

### DETAILED DESCRIPTION

It should, of course, be understood that the description and drawings herein are merely illustrative and that various modifications and changes can be made in the structures disclosed without departing from the present disclosure. Spatially relative terms may be used to describe an element and/or feature's relationship to another element(s) and/or feature(s) as, for example, illustrated in the figures. Moreover, any term of degree used herein, such as “substantially” and “approximately”, means a reasonable amount of deviation of the modified word is contemplated such that the end result is not significantly changed.

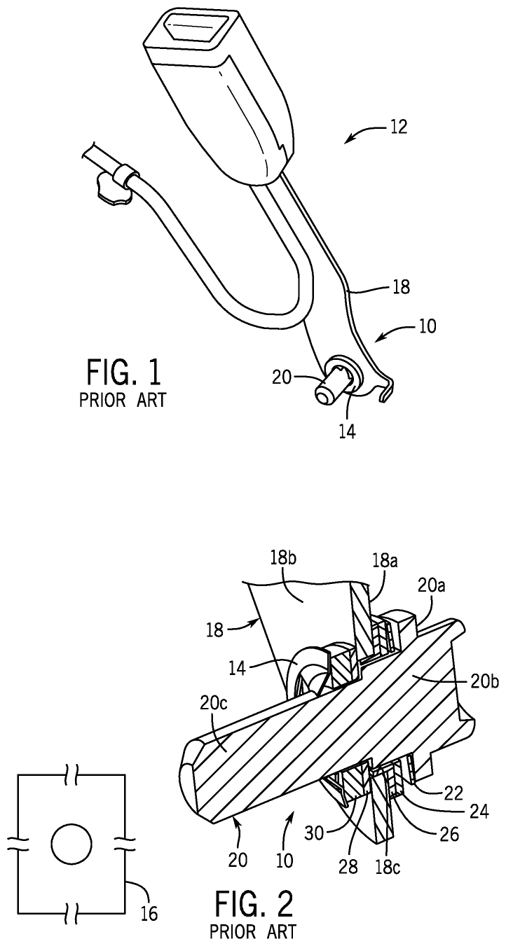

Referring now to the drawings, wherein like numerals refer to like parts throughout the several views, FIGS. 1 and 2 illustrate a known hold-together assembly 10, also referred to herein as a mounting assembly, which can be provided for transportation and/or handling of a part, such as the illustrated vehicle seatbelt buckle assembly 12. In particular, the hold-together assembly 10 of FIG. 1 includes a toothed washer 14 that functions to secure the several components of the hold-together assembly 10 as assembled and in position through transportation and handling until the buckle assembly 12 is installed, such as by being fastened or secured to a vehicle seat frame, which is illustrated schematically at reference numeral 16 in FIG. 2.

As shown, the known hold-together assembly 10 includes an anchor plate or bracket 18 having first and second sides 18a, 18b, a bolt 20 received through a hole 18c defined in the anchor plate 18 and the toothed washer 14 received on the bolt 20 to axially secure the bolt 20 to the anchor plate 18 while allowing relative rotation between the bolt 20 and the anchor plate 18. The hold-together assembly 10 additionally includes a spring washer 22, an annular washer 24 and a bushing 26, all disposed annularly on a first shaft portion 20b of the bolt 20 between a head portion 20a of the bolt 20 and the first side 18a of the anchor plate 18. Also, the hold-together assembly 10 optionally includes first and second underside washers 28, 30 disposed annularly on a second shaft portion 20c of the bolt 20 between the toothed washer 14 and the second side 18b of the anchor plate 18.

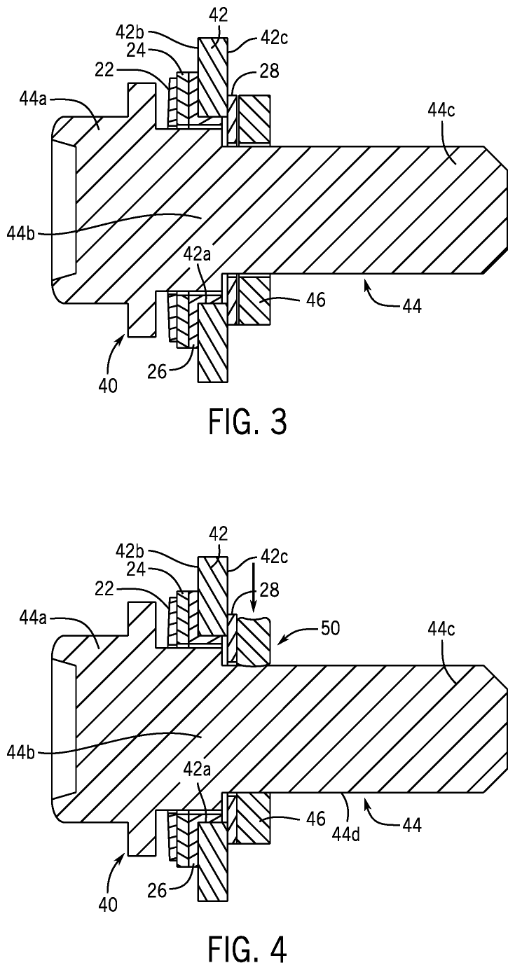

With reference now to FIG. 3, a hold-together or mounting assembly 40 is illustrated according to one embodiment of the present disclosure. As will be described in more detail below, the hold-together assembly 40 includes a working part 42 adapted to be secured to an associated mounting part, which can be the seat frame 16 of FIG. 2 for example, and a threaded member 44 received through an aperture 42a of the working part 42. In one nonlimiting example, the working part 42 could be anchor plate or bracket 18 of a seatbelt buckle assembly (e.g., seatbelt buckle assembly 12 of FIG. 1) and the aperture 42a could be the hole 18c defined in the anchor plate 18 of FIGS. 1 and 2, though this is not required. Alternatively, the working part 42 could be a part in some other vehicle sub-assembly or a nonvehicle assembly. Likewise, the threaded member 44 could be the bolt 20 of FIGS. 1 and 2, though this is also not required.

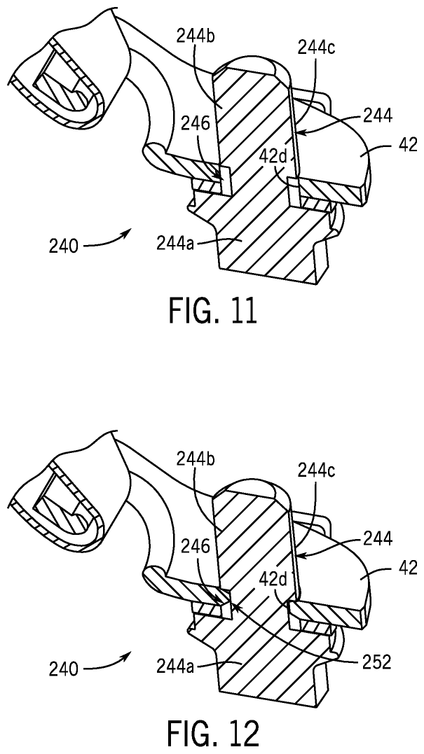

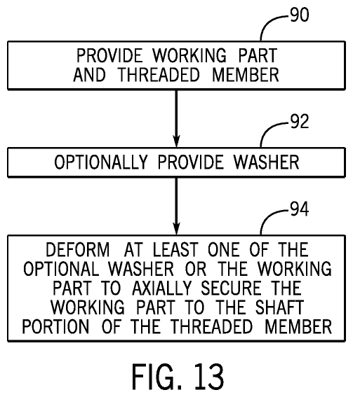

Additionally, the hold-together assembly 40 can include a washer 46 annularly received on a shaft portion 44c of the threaded member 44 for holding the threaded member 44 relative to the working part 42. More particularly, in the embodiment illustrated in FIG. 3, the illustrated hold-together assembly 40 does include the washer 46 annularly received on the shaft portion 44c of the threaded member for holding the threaded member 44 relative to the working part 42 as will be described in more detail below. In other embodiments (e.g., see FIGS. 11-12), the washer 46 can be excluded and therefore is referred to herein as an optional washer. Also in the illustrated embodiment, the threaded member 44 includes head portion 44a disposed on a first side 42b of the working part 42 and a first shaft portion 44b received through the aperture 42a and axially aligned with the working part 42, or a portion thereof, defining the aperture 42a, which is a hole or throughhole in the illustrated embodiment. As such, the shaft portion 44c is a second shaft portion disposed distally relative to the first shaft portion 44b and relative to the head portion 44a of the threaded member 44. The washer 46 is annularly received on the second shaft portion 44c of the threaded member 44 and is disposed on a second side 42c of the working part 42. Receipt of the washer 46 on the shaft portion 44c of the threaded member 44 allows relative rotation of the threaded member 44, particularly relative to the working part 42, while inhibiting axial movement of the threaded member 44, particularly the shaft portion 44c of the threaded member 44, relative to the working part 42.

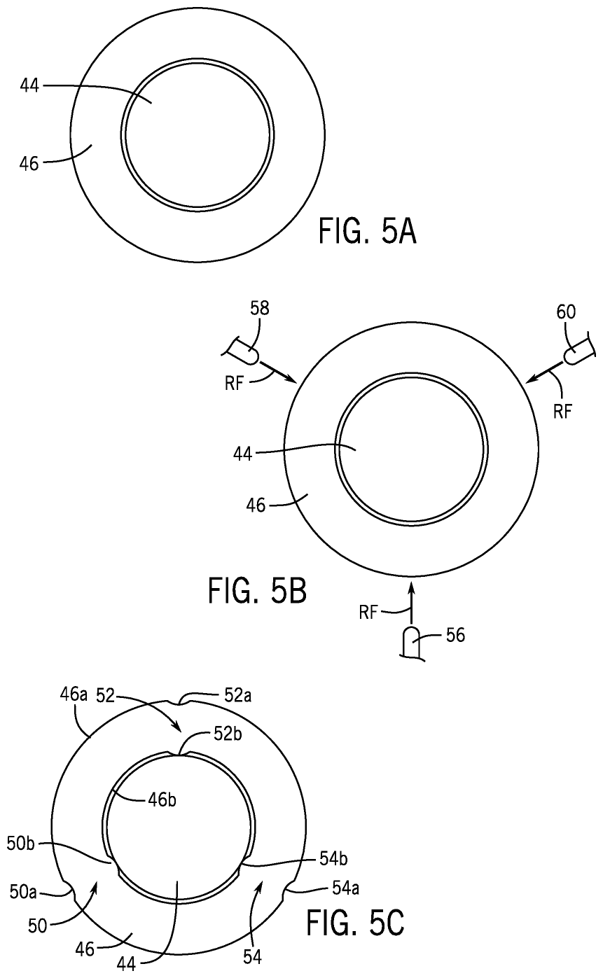

For holding the threaded member 44 in position, particularly axially, relative to the working part 42, and with additional reference to FIG. 4, the hold-together assembly 40 further includes at least one deformation (e.g., deformations 50, 52, 54 shown in FIG. 5C) formed in the washer 46 (or in the working part 42 in other embodiments with the washer optionally excluded) to axially secure the working part 42 to the shaft portion 44c of the threaded member 44 for inhibiting axial movement between the working part 42 and the threaded member 44 while allowing relative rotation between the shaft portion 44c of the threaded member 44 and the working part 42. More particularly, in the embodiment illustrated in FIG. 4, the at least one deformation (e.g., deformations 50, 52, 54) is formed in the washer 46. As will be described in more detail below, the at least one deformation (e.g., deformations 50, 52 and 54) can be applied to the working part 42 after the shaft portion 44c of the threaded member 44 is inserted into the aperture 42a of the working part 42.

More specifically, the at least one deformation is applied to the washer 46 after the washer 46 is annularly received on the shaft portion 44c of the threaded member 44. In particular, and the same or similar to the embodiment of FIGS. 1 and 2, the hold-together assembly 40 of FIGS. 3 and 4 can include the spring washer 22, the annular washer 24 and the bushing 26, all of which are annularly received on the first shaft portion 44b of the threaded member 44 and are disposed between the head portion 44a and the first side 42b of the working part 42. Also, the hold-together assembly 40 can include the first underside washer 28, as shown. It is to be understood that the first underside washer could be excluded (i.e., no underside washers used) or more than a single underside washer could be used (i.e., any number of underside washers could be used).

In the embodiment of FIG. 4, the at least one deformation is at least one radial deformation (e.g., radial deformation 50) extending axially into threads 44d on the shaft portion 44c of the threaded member 44 thereby inhibiting axial movement between the washer 46 and the threaded member 44 while permitting relative rotation between the working part 42 and the threaded member 44. This also functions to hold the other components of the hold-together assembly 40 together, namely, the spring washer 22, the annular washer 24, the bushing 26, the working part 42 and the underside washer 28. In a more specific embodiment, the at least one radial deformation can be at least two radial deformations (e.g., at least two of radial deformations 50, 52 and 54) circumferentially spaced around the washer 46 and circumferentially equidistant apparat from one another. In any of these embodiments, the at least one radial deformation (e.g., radial deformation 50) can be deformed sufficiently into the threaded member 44 so as to prevent relative rotation between the washer 46 and the threaded member 44 (while still allowing relative rotation between the threaded member 44 and the working part 42) or can reduced (i.e., slightly deformed) so as to allow relative rotation between the washer 46 and the threaded member 44.

In the specific embodiment illustrated in FIG. 4, and with further references to FIGS. 5A, 5B and 5C, the at least one radial deformation can include three (3) radial deformations 50, 52, 54 extending radially into the threads 44d of the threaded member 44. FIG. 5A schematically shows the washer 46 and the threaded member 44 prior to the deformations 50, 52, 54 being applied to the washer 46. As shown in FIG. 5B, the deformations 50, 52, 54 can be applied by the schematically illustrated tool dies or press parts 56, 58, 60 applying radial forces, illustrated by arrows RF, to the washer 46. As shown, each deformation 50, 52, 54 is formed by the corresponding tool die 56, 58, 60 contacting an outer radial surface 46a of the washer 46 at circumferentially spaced apart locations. This causes the outer radial surface 46a to deform radially inwardly as shown as outer radial deformation portions 50a, 52a and 54a and thereby deform the inner radial surface 46b of the washer 46 radially into the threads 44d as shown by inner radial deformations portions 50b, 52b, 54b. Thus, each deformation 50, 52, 54 is formed by the respective tool die 56, 58, 60 forcibly contact the outer radial surface 46a of the washer 46, forcibly deforming the outer radial surface 46a in a radially inward direction and thereby deforming the inner radial surface 46b of the washer 46 into contact with the threads 44d disposed on the shaft portion 44c of the threaded member 44.

This advantageously inhibits axial movement between the washer 46 and threaded member 44 to thereby axially lock the threaded member 44 to the working part 42 while still permitting relative rotation between the threaded member 44 and the working part 42. Permitting such relative movement allows the threaded member 44 to be installed on an associated mounting part, such as a vehicle seat frame. Inhibiting axial movement can be sufficient to maintain the assembly 10 in its assembled state, such as during shipping and handling, in which the assembly 10 may be subject to vibrations or low torque forces. The assembly 10 allows for elimination of the use of a further component, such as the toothed washer 14 of FIGS. 1 and 2, advantageously reducing the number of parts necessary and thus the overall cost and/or weight of the assembly 10. While the illustrated embodiment shows the application of the radial force RF at three locations to form the three corresponding radial deformations 50, 52, 54, it is to be appreciated that a single radial deformation or a pair of radial deformations could be employed, or more than three radial deformations could be employed. Additionally, while the radial deformations are described as being circumferentially spaced and circumferentially equidistant from one another, though this is not required.

When the hold-together assembly 40 is used for a vehicle sub-assembly, such as the seatbelt buckle assembly 12 of FIG. 1 or some other vehicle sub-assembly, the working part 42 is adapted to be secured to an associated vehicle mounting part, such as the vehicle seat frame 16 in FIG. 2 or some other vehicle mounting part. In this application, the threaded member 44 can be a bolt received through the aperture 42a defined in the working part 42 and the at least one deformation (e.g., deformations 50, 52, 54 or deformations 62, 64, 66) can extend axially into or toward the threaded member 44 to axially inhibit movement between the threaded member 44 and the working part 42 while allowing relative rotation between the threaded member 44 and the working part 42.

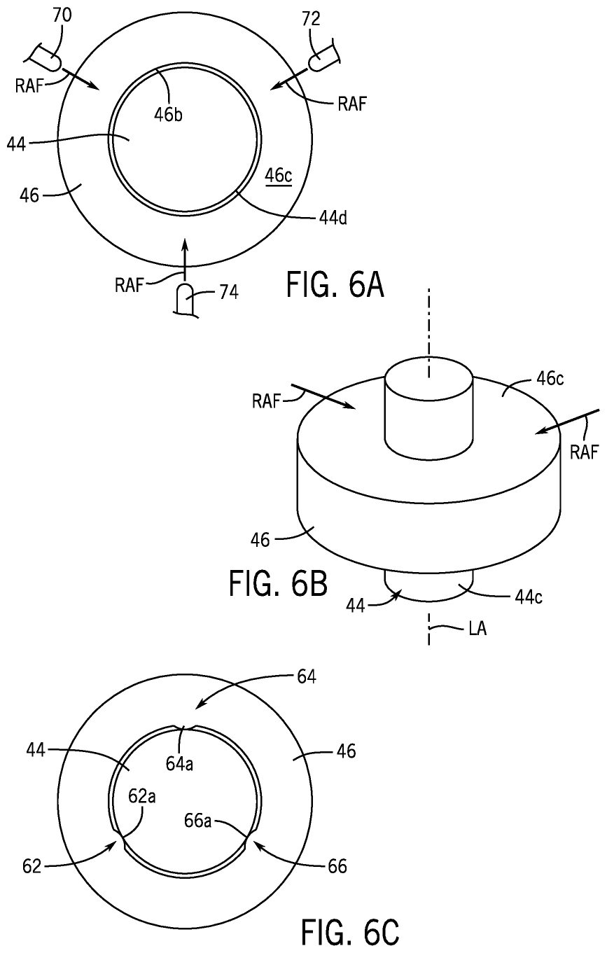

In an alternate embodiment, with reference to FIGS. 6A-6C, the at least one radial deformation is formed by applying a combined radial and axial force (e.g., force RAF) to the washer 46. Except as described below, this embodiment can be the same or similar to that described hereinabove in reference to FIGS. 4 and 5A-5C. In the example illustrated in FIGS. 6A-6C, the at least one radial deformation can include at least one combined radial and axial deformation formed by applying the combined radial and axial force RAF to the washer 46. As shown, the combined radial and axial force RAF can be applied to an exposed axial surface 46c of the washer 46 wherein the force RAF is applied to the axial surface 46c at an acute angle relative to a longitudinal axis LA of the threaded member 44. In a specific further embodiment, the forces RAF could be applied at three locations that are circumferentially spaced apart around the washer 46 and circumferentially equidistant from one another, though this is not required and less than three or more than three locations could be used to form a corresponding number of deformations.

When the at least one deformation is at least one radial and axial deformation, such as the radial and axial deformations 62, 64, 66 shown in FIG. 6C, each deformation 62, 64, 66 can extend both radially and axially into the threads 44d disposed on the shaft portion 44c of the threaded member 44 to thereby inhibit axial movement between the washer 46 and the threaded member 44. As shown in FIG. 6A, the deformations 62, 64, 66 can be applied by the schematically illustrated tool dies or press parts 70, 72, 74 forcibly contacting the exposed axial surface 46c of the washer 46 facing away from the working part 42, applying the respective combined radial and axial forces RAF to the axial surface 46c and thereby forcibly deforming the axial surface 46c in a radially inward direction and an axially downward direction (i.e., toward the working part 42), and thereby deforming the inner radial surface 46b of the washer 46 into contact with the threads 44d disposed on the shaft portion of the threaded member 44. As also shown, each deformation 62, 64, 66 is formed by the corresponding tool die 70, 72, 74 contacting the exposed axial surface 46c of the washer 46 at circumferentially spaced apart locations. This can cause the axial surface 46b to deform and thereby deform the inner radial surface 46b of the washer at least radially into the threads 44d as shown by the inner radial deformation portions 62a, 64a, 66a, and optionally also axially into the threads 44d.

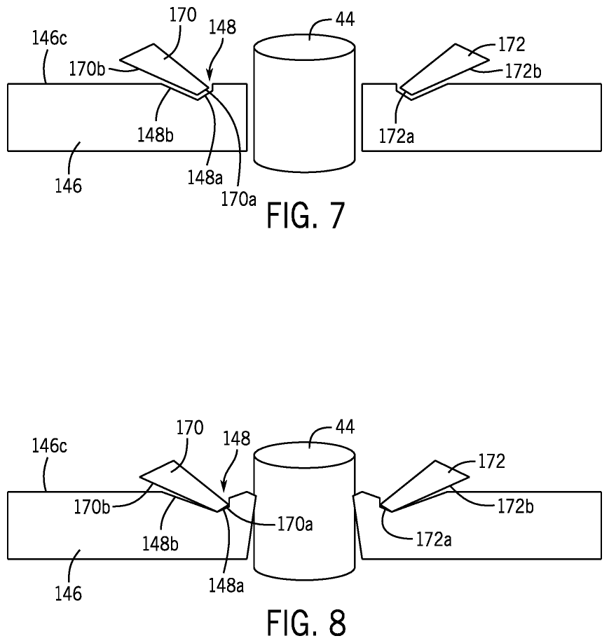

With further reference to FIGS. 7 and 8, an alternate embodiment is schematically shown wherein the washer 46 is replaced with washer 146 having a tool die receipt groove 148 defined in exposed axial surface 146c of the washer 146. Except as described herein, the washer 146 can be the same or similar as the washer 46. The groove 148 can be shaped to matingly receive tool dies 170 and 172, which are used in place of the tool dies 70, 72, 74 of FIGS. 6A-6C. In particular, the groove 148 can have angled surfaces 148a, 148b that engage corresponding angled surfaces 170a, 170b and 172a, 172b of the tool dies 170, 172. This cooperative engagement between the tool dies 170 and the groove 148 can eliminate or reduce radial slippage between the tool dies 170, 172 and the exposed axial surface 146c of the washer 146.

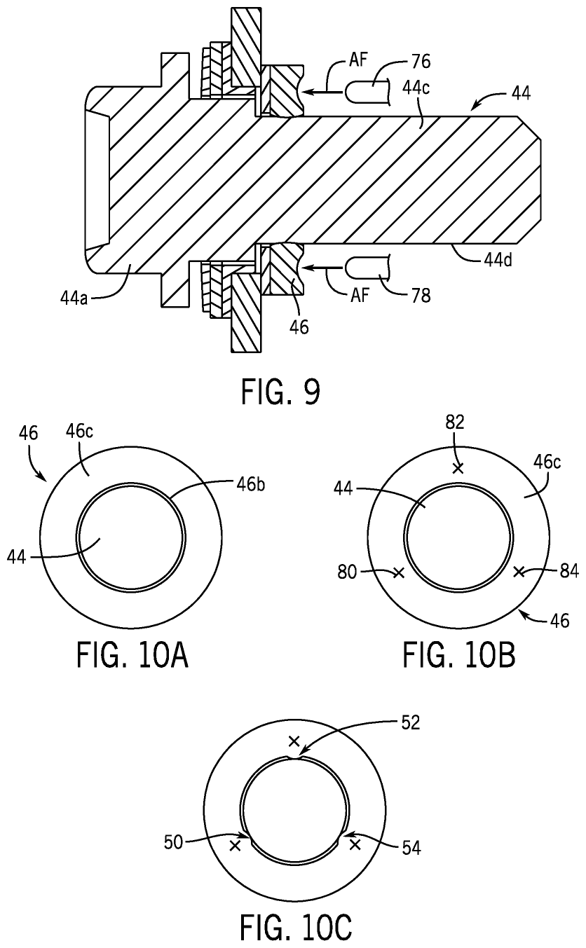

In yet another alternate embodiment, with reference to FIGS. 9 and 10A-10C, the at least one radial deformation is formed by applying only an axial force or forces (e.g., axial force(s) AF) to the washer 46. In this embodiment, tool dies or press parts (only two tool dies 76, 78 shown in FIG. 9) forcibly contact the exposed axial surface 46c of the washer 46, the surface 46c also referred to herein as an axial annular surface that faces away from the working part 42, forcibly deform the axial surface 46c in an axially downward direction (i.e., a direction toward the working part 42), and forcibly deform the inner radial surface 46b of the washer 46 into contact with the threads 44d disposed on the shaft portion 44c of the threaded member 44. In most respects, this embodiment is the same or similar to the embodiment of FIGS. 3, 4 and 5A-5C except that only axial force is applied to the washer 46 and only onto the surface 46c. As shown in FIGS. 10B and 10C, the axial force AF can be applied at three locations on the surface 46c at circumferentially spaced apart locations 80, 82, 84 that are circumferentially equidistant from one another, though there could be less than three locations or more than three locations (and optionally the locations do not need to be equidistant apart from one another). Applying only axial force AF to the washer 46 can still result in the radial deformations 50, 52, 54 as shown in FIG. 10C that inhibit axial movement of the shaft portion 44c of the threaded member 44 relative to the working part 42 while allowing relative rotation.

In still another alternate embodiment, with reference to FIGS. 11 and 12, a hold-together assembly 240 is shown in which the threaded member 44 of the hold-together assembly 40 is replaced by threaded member 244 having an annular radial recess or undercut 246, which eliminates the need for the washer 46 as will be described in more detail below. In particular, the threaded member 244 defines the annular recess 246 axially adjacent a head portion 244a of the threaded member 244 and radially into a shaft portion 244b of the threaded member 244 axially between threads 244c and the head portion 244a. More specifically, the shaft portion 244b of the threaded member 244 defines the annular radial recess 246 at a location in axial alignment with the working part 42, which can be the working part of the hereinabove described embodiments, and particularly in axial alignment with an aperture forming surface 42d of the working part 42 that defines the aperture 42a.

In this embodiment, which excludes the washer 46, the at least one deformation (e.g., illustrated radial deformation 252) is formed in the working part 42 such that the aperture forming surface 42d of the working part 42 extends radially into the annular radial recess 246 to inhibit axial movement between the working part 42 the threaded member 244 while allowing relative rotation between the shaft portion 244b of the threaded member 244 and the working part 42. The at least one deformation to the working part 42 in this embodiment can be in accord with any of the embodiments discussed hereinabove. For example, the at least one deformation 252 can be a radial deformation (or a plurality of radial deformations) obtained by applying a radial force to the working part 42. Alternatively, the deformation 252 could be formed by applying a combined radial and axial force to deform the working part 42 into the radial recess 246 or an axial only force to deform the working part 42 into the radial recess 246. Still further, the working part 42 could be modified so as to have a cooperative recess for cooperatively receiving a tool die similar to or in accord with the embodiment of FIGS. 7 and 8 (i.e., the cooperative recess would be formed in the working part 42 instead of in the washer 46).

With reference now to FIG. 12, a hold-together assembly method will be described. In particular, the hold-together assembly method will be described in association with the embodiments described herein, though it is to be understood that the method is not limited to the hold-together assemblies described herein. In the method, as indicated as step 90, the working part 42 adapted to be secured to an associated mounting part (e.g., vehicle seat frame 16) and the threaded member 44 having the shaft portion 44c received through the aperture 42a in the working part 42 are provided. As indicated at step 92, the washer 46 that is annularly received on the shaft portion 44c of the threaded member 44 is optionally provided. More particularly, the washer 46 is provided when it is the washer 46 that is used to inhibit axial movement between the working part 42 and the threaded member 44 while allowing relative rotation between the shaft portion 44c of the threaded member 44 and the working part 42. Alternatively, the washer 46 is not provided for example when the embodiment of FIG. 11 is employed and the working part 42 is deformed in place of the washer 46.

As indicated at step 94, at least one of the washer 46 or the working part 42 is deformed in the method to axially secure the working part 42 to the shaft portion 44c of the threaded member 44 for inhibiting axial movement between the working part 42 and the threaded member 44 while allowing relative rotation between the shaft portion 44c of the threaded member 44 and the working part 42. In particular, the washer 46 is deformed when included and can be deformed in accord with any of the embodiments disclosed herein. Alternatively, the washer 146 can be provided in place of the washer 46 and then it is the washer 146 that is deformed. Also alternatively, the working part 42 can be deformed when the washer 46 is excluded as described hereinabove with respect to the embodiment of FIG. 11.

In the method, the step 94 can include deforming the washer 46 to axially secure the washer 46 to the shaft portion 44c of the threaded member 44 and can further include radially deforming the outer radial surface 46a of the washer 46 to thereby deform an inner radial surface 46b of the washer 46 into contact with the threads 44d disposed on the shaft portion 44c of the threaded member 44. Alternatively, the step 94 can include deforming the washer 46 to axially secure the washer 46 to the shaft portion 44c of the threaded member 44 and can further include axially deforming an axial annular surface of the washer facing away from the working part to thereby deform an inner radial surface 46b of the washer 46 into contact with the threads 44d disposed on the shaft portion 44c of the threaded member 44.

Alternatively, when no washer 46 is provided in step 92, the step 94 can include deforming the working part 42 into an annular radial recess 246 disposed at a location in axial alignment with an aperture forming surface 42d of the working part 42 that forms the aperture 42a in the working part 42, such as discussed in accord with the embodiment shown in FIGS. 11 and 12. In this embodiment, the at least one deformation (e.g., deformation 252) can be formed in the working part 42 such that the aperture forming surface 42d of the working part 42 extends radially into the annular radial recess 246 to inhibit axial movement between the working part 42 and the threaded member 244 while allowing relative rotation between the shaft portion 244b of the threaded member 244 and the working part 42.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A hold-together assembly, comprising:
a working part adapted to be secured to an associated mounting part;
a threaded member having a shaft portion received through an aperture in the working part;
an optional washer annularly received on the shaft portion of the threaded member for holding the threaded member relative to the working part; and
at least one deformation formed in the optional washer or the working part to axially secure the working part to the shaft portion of the threaded member for inhibiting axial movement between the working part and the threaded member while allowing relative rotation between the shaft portion of the threaded member and the working part.

2. The hold-together assembly of claim 1, wherein the threaded member includes a head portion disposed on a first side of the working part, and wherein the optional washer is disposed on a second side of the working part.

3. The hold-together assembly of claim 1, wherein the washer is annularly received on the shaft portion of the threaded member and wherein receipt of the washer on the shaft portion of the threaded member allows relative rotation of the threaded member while inhibiting axial movement of the shaft portion of the threaded member relative to the working part.

4. The hold-together assembly of claim 1, wherein the washer is annularly received on the shaft portion and said at least one deformation is formed in the washer.

5. The hold-together assembly of claim 4, wherein said at least one deformation is applied to the washer after the washer is annularly received on the shaft portion of the threaded member.

6. The hold-together assembly of claim 4, wherein said at least one deformation is at least one radial deformation extending radially into threads disposed on the shaft portion of the threaded member thereby inhibiting axial movement between the washer and the threaded member while permitting relative rotation between the working part and the threaded member.

7. The hold-together assembly of claim 6, wherein said at least one radial deformation is at least two radial deformations circumferentially spaced around the washer and circumferentially equidistant from one another.

8. The hold-together assembly of claim 6, wherein said at least one radial deformation is formed by a tool die forcibly contacting an outer radial surface of the washer, forcibly deforming the outer radial surface in a radially inward direction and thereby deforming an inner radial surface of the washer into contact with the threads disposed on the shaft portion of the threaded member.

9. The hold-together assembly of claim 4, wherein said at least one deformation is at least one radial and axial deformation extending both radially and axially into threads disposed on the shaft portion of the threaded member thereby inhibiting axial movement between the washer and the threaded member.

10. The hold-together assembly of claim 9, wherein said at least one deformation is formed by a tool die forcibly contacting an axial annular surface of the washer facing away from the working part, forcibly deforming the axial annular surface of the washer in a radially inward direction and an axially downward direction, and deforming an inner radial surface of the washer into contact with the threads disposed on the shaft portion of the threaded member.

11. The hold-together assembly of claim 9, wherein said at least one deformation is formed by a tool die forcibly contacting an axial annular surface of the washer facing away from the working part, forcibly deforming the axial annular surface of the washer in an axially downward direction, and deforming an inner radial surface of the washer into contact with the threads disposed on the shaft portion of the threaded member.

12. The hold-together assembly of claim 2 wherein the shaft portion of the threaded member defines an annular radial recess disposed at a location in axial alignment with an aperture forming surface of the working part that forms the aperture in the working part, and wherein said at least one deformation is formed in the working part such that the aperture forming surface of the working part extends radially into the annular radial recess to inhibit axial movement between the working part and the threaded member while allowing relative rotation between the shaft portion of the threaded member and the working part.

13. The hold-together assembly of claim 12, wherein said at least one deformation is applied to the working part after the shaft portion of the threaded member is inserted into the aperture of the working part.

14. The hold-together assembly of claim 1 wherein the working part is an anchor plate of a seatbelt buckle assembly.

15. A hold-together assembly for a vehicle sub-assembly, comprising:
a working part adapted to be secured to an associated vehicle mounting part;
a bolt received through a bolt aperture defined in the working part;
at least one deformation extending axially into or toward the bolt to axially inhibit movement between the bolt and the working part while allowing relative rotation between the bolt and the working part.

16. The hold-together assembly of claim 15 wherein said at least one deformation is formed in a washer annularly received on the bolt.

17. A hold-together assembly method, comprising:
providing a working part adapted to be secured to an associated mounting part and a threaded member having a shaft portion received through an aperture in the working part;
optionally providing a washer annularly received on the shaft portion of the threaded member;
deforming at least one of the optional washer or the working part to axially secure the working part to the shaft portion of the threaded member for inhibiting axial movement between the working part and the threaded member while allowing relative rotation between the shaft portion of the threaded member and the working part.

18. The hold-together assembly method of claim 17 wherein said deforming includes deforming the washer to axially secure the washer to the shaft portion of the threaded member and further includes radially deforming an outer radial surface of the washer to thereby deform an inner radial surface of the washer into contact with threads disposed on the shaft portion of the threaded member.

19. The hold-together assembly method of claim 17 wherein said deforming includes deforming the washer to axially secure the washer to the shaft portion of the threaded member and further includes axially deforming an axial annular surface of the washer facing away from the working part to thereby deform an inner radial surface of the washer into contact with threads disposed on the shaft portion of the threaded member.

20. The hold-together assembly method of claim 17 wherein said deforming includes deforming the working part into an annular radial recess disposed at a location in axial alignment with an aperture forming surface of the working part that forms the aperture in the working part, and wherein said at least one deformation is formed in the working part such that the aperture forming surface of the working part extends radially into the annular radial recess to inhibit axial movement between the working part and the threaded member while allowing relative rotation between the shaft portion of the threaded member and the working part.
